(19) United States
(12) Patent Application Publication
(10) Pub. No.: US 2009/0221275 A1
(43) Pub. Date: Sep. 3, 2009

(54) METHOD AND SYSTEM FOR ESTABLISHING CONNECTION TRIGGERED BY MOTION

(75) Inventor: Bart TRIP, Emmen (NL)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/038,948

(22) Filed: Feb. 28, 2008

(51) Int. Cl. H04M 3/00

(52) U.S. Cl. 455/418

(57) ABSTRACT

Numerals crossed out in abstract and typographical error corrected. A method and system for establishing a connection or service between two mobile devices within a communication network is provided. At least one of the mobile devices includes a motion detector, which detects a movement of the mobile device. Connections between the mobile devices are established based upon the detection of movement of at least one of the devices.

### TECHNICAL FIELD

The present invention relates to the field of mobile devices and, more particularly, to mobile devices comprising a motion detection unit and a method and system for establishing a connection or service between two mobile devices triggered by motion.

### BACKGROUND ART

A variety of portable electronic devices, such as mobile devices (e.g. mobile telephones, PDAs, media players and/or handheld computers), are widely used today. In many of these mobile devices a motion detector is included.

The mobile devices of today have the ability to connect with other devices by using short range communication systems, e.g. Bluetooth® or WLAN. For example, using Bluetooth approach to provide communication or service functions between two mobile devices, it usually would be necessary to turn on the Bluetooth® functions of both mobile devices, to wait a period of time for one mobile device to detect the nearby mobile device with Bluetooth activated, select the desired mobile device for establishing connection (pairing), and then provide the communication or service function to that mobile device. The time it would take to turn on the Bluetooth function, to select the correct mobile device and to create connections on a communication or service event is relatively lengthy. Furthermore, this will lead to degradation of services and a lower user experience. Typical examples are: missing an incoming call indication or caller name or number identification.

When two Bluetooth devices are paired together they usually try to connect to each other on certain events. Examples of known events are: after power on of the device, after a key press upon service or application event, e.g. incoming call or sending of a message. These methods are reactive due to the fact that they are triggered by a service request or user action and do not cope with connection loss due to RF characteristics of Bluetooth. For that reason some products have implemented a reconnection policy based on timing, i.e. they try to reconnect on certain time intervals (e.g. every hour).

Although, several of the above issues are described with respect to the Bluetooth function, it will be appreciated that similar or same issues may arise with respect to providing connection and service functions between different mobile devices using other short range communication systems.

### SUMMARY OF THE INVENTION

With the above description in mind, then, an aspect of some embodiments of the present invention is to provide a method and system for establishing connections between two mobile devices triggered by motion and to maintain the connection when in motion or in use, which seeks to mitigate, alleviate or eliminate one or more of the above-identified deficiencies in the art and disadvantages singly or in any combination.

An aspect of the present invention relates to a method for establishing connection between a first electronic device and at least a second electronic device in a communication network. Wherein at least the first electronic device comprise a motion detection unit adapted to detect motion of the first electronic device. The method comprises the steps of moving the first electronic device and detecting the movement of the first electronic device by use of the motion detection unit. Further on the method comprises the steps of establishing a connection between the first and second electronic device in response to the detected movement and setting at least the first electronic device in an active mode.

In one embodiment, the method further comprises the steps of maintaining the connection between the first and second electronic device when at least the first electronic device is in the active mode.

In one embodiment, the method further comprises the step of disconnecting the first and second electronic device due to lack of detection of movement and setting the first electronic device in a sleep mode.

In one embodiment, is lack of detected movement no detected movement for a predetermined time period.

Another aspect of the present invention relates to a system for establishing connection between electronic devices within a communication network. The system comprises a first electronic device and at least a second electronic device and a motion detector comprised in at least the first electronic device for detecting a movement of the first electronic device. Further on the system comprises means for establishing connections between the first electronic device and the at least second electronic device based upon detection of movement and means for setting at least the first electronic device in an active mode.

In one embodiment the system further comprises means for maintaining established connection between the first and at least the second electronic device when at least the first electronic device is set in active mode.

In one embodiment the system further comprises means for disconnecting the first electronic device from at least the second electronic device due to lack of detection of movement and means for setting the first electronic device in a sleep mode.

In one embodiment the lack of detected movement is no detected movement for a predetermined time period.

In one embodiment the system is a short range wireless system.

In one embodiment the system is a Bluetooth system or a WLAN system.

The features of the above-mentioned embodiments can be combined in any combinations.

Some embodiments of the invention provide an improved method for determining if a mobile device is in use or not, i.e. in motion or not, and use that information to connect or disconnect the mobile device by using motion as a trigger for connection. It is an advantage with some embodiments of the invention that they maximizes the probability of being connected when needed and thus increase the user-experience. It is another advantage with some embodiments of the invention that they may allow for battery saving when not in use, i.e. not in motion.

### BRIEF DESCRIPTION OF THE DRAWINGS

Further objects, features and advantages of the present invention will appear from the following detailed description of the invention, wherein embodiments of the invention will be described in more detail with reference to the accompanying drawings, in which:

FIG. 1 illustrates a mobile device in accordance with an embodiment of the invention;

FIG. 2 is a schematic flowchart representing the relevant operation of the mobile device in accordance with an embodiment of the invention.

### DETAILED DESCRIPTION

Embodiments of the present invention relate, in general, to the field of electronic devices including a motion detector unit. A preferred embodiment relates to a portable communication device, such as a mobile device, including a motion detector unit. However it should be appreciated that the invention is as equally applicable to other electronic devices which do include all radio communication capabilities. However, for the sake of clarity and simplicity, most embodiments outlined in this specification are related to mobile devices.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

From the description summarized above and described in further details below, it will be appreciated that a short range communication system between mobile devices may be used to transfer communication or service functions between the mobile devices. Using motion sensing function of the present invention, a communication connection or link and an appropriate communication protocol can be established between mobile devices. Upon establishing the connection and the appropriate communication protocol between the desired mobile devices, whether two or more, the short range communication system mentioned above may be used to transfer communication or service functions from one mobile device to the other mobile devices(s).

Exemplary embodiments will now be described with references made to accompanying drawing.

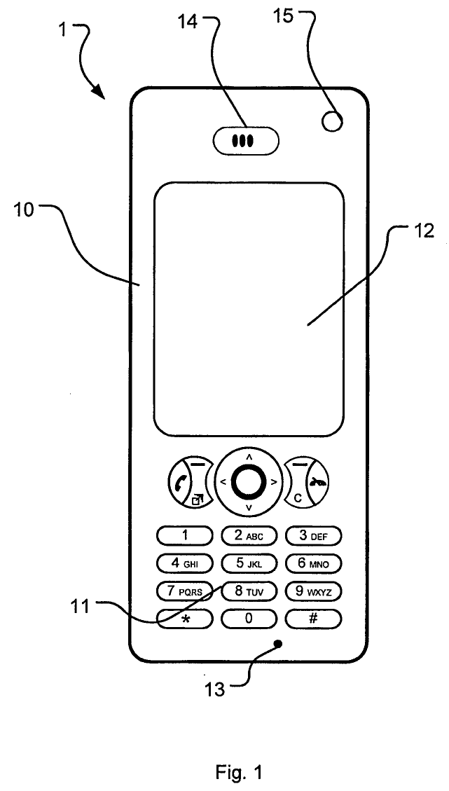

FIG. 1 discloses a mobile device 1 comprising housing 10, a keypad or keyboard 11 and a display 12. Typically, the mobile device may also include a microphone 13 and a speaker 14. The mobile device also comprises radio transceiver circuitry (not shown) and antenna 15. The specific function and design of the mobile device as a communication device is known to persons skilled in the art, and will therefore not be described in any greater detail herein. It should also be noted that the list of features and elements included in the mobile device is in no way exhaustive. On the contrary, while the mobile device described represents only one possible embodiment, it may well comprise further features and elements providing other functions. Also, it should be appreciated that some of the elements listed above are not of importance for the invention as such and can be dispensed within other embodiments.

The mobile device 1 further includes a short range communication mechanism, for example a Bluetooth communication device, infrared (IR) communication device, or some other device. Another example of short range mechanism is wireless local area network (WLAN), and the invention also may use still other short range communication mechanisms or devices that currently exist or may be developed in the future.

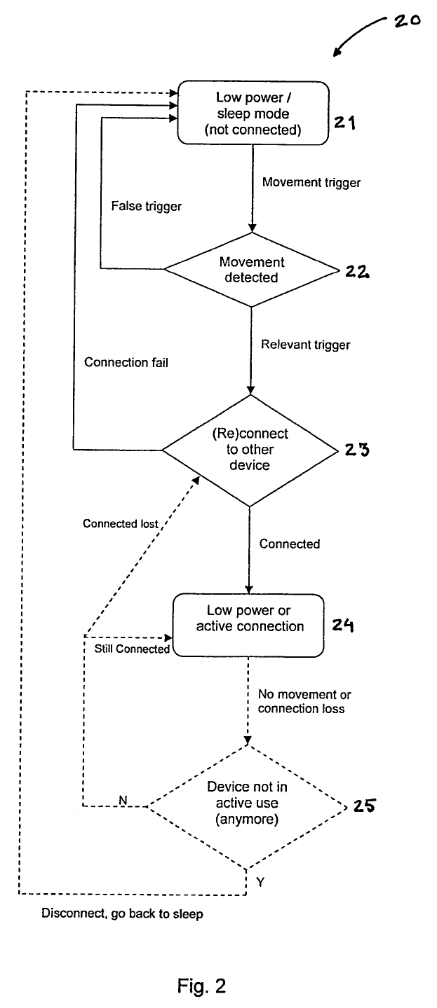

Referring to FIG. 2, a method of using and carrying out the invention is illustrated. The mobile device according to the invention may be comprised in a network comprising one or more electronic devices. According to one embodiment, all devices within the network “know” each other. At step 21 the mobile device is in low power mode or sleep mode, i.e. disconnected. At step 22 a connection is established between two mobile devices triggered by movement of at least one mobile device, as will be described further below. A user may move the device by shaking, swinging or by some other type of intended motion. The movement or motion pattern of the mobile device may be detected or recognized by a motion detector unit within the mobile device. A communication protocol or link may be established between the mobile device and another mobile device or between the mobile device and the network when an appropriate intended movement is recognized by motion detector unit of the mobile device. The mobile device is (re)connected to the network or another electronic device triggered by the detected motion and appropriate communication or service functions may be transferred, such as receiving a phone call or a message.

Intended motion means motion occurring due to walking, jogging, and riding in a vehicle or even raising the mobile device to the ear of a user as compared to unintended motion occurring due to accidental moving of the mobile device such as moving the device from one table to another or someone or something is bumping into the device.

The motion detection unit may include a motion sensor, for example, an accelerometer or an acceleration transducer. The motion detection unit and/or the mobile device may also include appropriate circuitry and programming or logic. An accelerometer may provide an output signal representing acceleration of the unit. The accelerometer may also be provided in the housing of the mobile device. The output signal represents the motion occurring when the mobile device is moved. Although, the motion detector unit has been described as comprising an accelerometer or acceleration transducer as motion sensor, it will be appreciated that the motion detection unit may include any device, circuitry or other mechanism or combination thereof that provides an indication that motion has been sensed.

FIG. 2 illustrates a representative flowchart showing an example of steps, functions and methods that may be carried out using the invention. The steps shown in the flow chart may be carried out using a mobile device of the type described herein or other type of communication device. Appropriate programming code may be written in an appropriate computer language or the like to carry out the steps, functions and methods as now are described with respect to FIG. 2.

At step 21, the method starts. Starting may include turning on the mobile device without connecting. The device is in low power mode or sleep mode and disconnected.

At step 22, a movement algorithm determines whether movement is intended or not, as described above. If not, then a loop is followed back to step 21 and mobile device remains in sleep mode. The algorithm depends on the type of device, e.g. watch, car kit, mobile phone, and can include several parameters like velocity, acceleration, distance etc.

If detected movement is intended at step 22, then at step 23 the output signal from the motion detection unit is provided to a control circuit to set up a communication protocol and communication link to establish communication with another mobile device or a personal area network to transfer and receive communication or service functions as described above.

If (re)connection is failed a loop is followed back to step 21 and the mobile device remains in sleep mode.

At step 24, connections are established and the mobile device is in high power mode or active mode. Active mode means that the power is on and the mobile device is connected to another mobile device or a personal area network, i.e. the mobile device is available for other electronic devices.

At step 25, a special detection algorithm determines whether mobile device is in use or not. If not, i.e. if no movement has been detected for a predetermined time period, then a loop is followed back to block 21, where the mobile device is disconnected and put in sleep mode.

If mobile device is in use but connection is lost, then a loop is followed back to step 23 where the mobile device is reconnected.

By adding a motion detector to a mobile device one could, by means of a specific algorithm, detect if the device is being used (moved). This information is then used to trigger (re)connection to a peer device(s) in the personal network to maximize the probability of being connected without user action. A peer device is known to the man skilled in the art and will not be described any further. Another important advantage is that by using motion as additional information in the (re)connection policy one could avoid reconnecting when the device is not used, which would happen if the device were timer driven, and this will also save battery power.

The system and method according to the present invention may be applied in all kinds of portable devices used in a personal area network, typically (but not limited to) a Bluetooth enabled mobile phone with one or more wireless accessories, like a Bluetooth watch, a Bluetooth headset and a Bluetooth car kit.

In one embodiment the mobile device is a Bluetooth enabled mobile phone with a Bluetooth watch. The phone and the watch “knows” each other, that is they have been paired before. The phone is connected with the watch when motion is detected, that a user wears the watch and is moving, i.e. walking. When the user takes off the watch and puts it on a sideboard, i.e. when going to bed, the Bluetooth device within the watch is put in sleep mode and disconnected from the phone. When the user put the watch on the wrist the watch and the phone reconnects without user intervention triggered by the movement of the devices.

In another embodiment, the mobile device is a Bluetooth enabled mobile phone with a Bluetooth car kit and the car kit is located in a car. It does not have to be fixed to a specific car, it may be moved to another place, such as into another car. When the user with the mobile phone drives the car, the mobile phone and the car kit is connected and as long as motion is detected the devices remains connected, triggered by the movement of the car and thus the devices. When the car is parked the Bluetooth device within the car kit is put in sleep mode and disconnected from the mobile phone, unless the user moves the car kit for some reason. When the user starts driving the car, the car kit reconnects to the mobile phone without user intervention. This specifically advantageous for a battery operated Bluetooth car kit, since the car kit is switch to sleep mode when the car is not used and that saves battery power, but as soon as the user starts driving the car the car kit reconnects to the mobile phone without user intervention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

In the foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A method for establishing connection between a first electronic device and at least a second electronic device in a communication network, wherein at least said first electronic device comprise a motion detection unit adapted to detect motion of said first electronic device, the method comprising the steps of:
moving said first electronic device;
detecting said movement of said first electronic device by use of said motion detection unit;
establishing a connection between said first and second electronic device in response to said detected movement; and
setting at least said first electronic device in an active mode.

2. The method according to claim 1, wherein the method further comprising the steps of:
maintaining the connection between said first and second electronic device when at least said first electronic device is set in said active mode.

3. The method according to claim 1, wherein the method further comprising the step of:
disconnecting said first and second electronic device due to lack of detection of movement; and
setting said first electronic device in a sleep mode.

4. The method according to claim 3, wherein lack of detected movement is no detected movement for a predetermined time period.

5. A system for establishing connection between electronic devices within a communication network, wherein said system comprising:
a first electronic device and at least a second electronic device;
a motion detector comprised in at least said first electronic device for detecting a movement of said first electronic device;
means for establishing connections between said first electronic device and said at least second electronic device based upon detection of movement; and
means for setting at least said first electronic device in an active mode.

6. The system according to claim 5, further comprising means for maintaining established connection between said first and at least said second electronic device when at least said first electronic device is set in said active mode.

7. The system according to claim 5, further comprising
means for disconnecting said first electronic device from at least said second electronic device due to lack of detection of movement; and
means for setting said first electronic device in a sleep mode.

8. The system according to claim 7, wherein lack of detected movement is no detected movement for a predetermined time period.

9. The system according to claim 5, wherein said system is a short range wireless system.

10. The system according to claim 5, wherein said system is a Bluetooth system or a WLAN system.
